(19) United States
(12) Patent Application Publication
(10) Pub. No.: US 2023/0305988 A1
(43) Pub. Date: Sep. 28, 2023

(54) IN-VEHICLE DEVICE, VEHICLE, AND METHOD

(71) Applicant: HONDA MOTOR CO.,LTD., Tokyo (JP)

(72) Inventors: Takato FUKUNO, Tokyo (JP); Yuki SAKAI, Tokyo (JP); Yu YOSHII, Tokyo (JP); Shoichi ITO, Tokyo (JP); Ryosuke HORIE, Tokyo (JP)

(21) Appl. No.: 18/188,483

(22) Filed: Mar. 23, 2023

(30) Foreign Application Priority Data
Mar. 28, 2022 (JP) 2022-051093

(51) Int. Cl. G06F 13/42

(52) U.S. Cl. CPC G06F 13/4282; G06F 2213/40

(57) ABSTRACT

An in-vehicle device includes: a reception unit configured to receive, via control area network communication (CAN communication), a message including data and an authentication code for authenticating the data; an authentication unit configured to authenticate the data by using the authentication code; and a control unit configured to perform control by using the data included in the message when the authentication unit has authenticated data included in a preset number of messages consecutively received by the reception unit. A method includes: receiving, via control area network communication (CAN communication), a message including data and an authentication code for authenticating the data; authenticating the data by using the authentication code; and when data included in two consecutively received messages is authenticated in the authenticating the data, performing control by using data included in a last received message among the two messages.

The contents of the following Japanese patent application(s) are incorporated herein by reference: NO. 2022-051093 filed on Mar. 28, 2022.

### BACKGROUND

### 1. Technical Field

The present invention relates to an in-vehicle device, a vehicle, and a method.

### 2. Related Art

Patent document 1 discloses an in-vehicle network system wherein preset treatments are performed if verification of a message authentication code (MAC) fails a certain number of times or greater. Patent document 2 discloses an electronic control apparatus wherein a message is assigned a MAC and then transmitted.

### Prior Art Documents

Patent Document 1: Japanese Patent Application Publication No. 2020-129801
Patent Document 2: WO2019/159593

### BRIEF DESCRIPTION OF THE DRAWINGS

FIG. 1 conceptually shows the system configuration of a vehicle 10 in an embodiment.

FIG. 2 is a block diagram schematically illustrating a functional configuration included in an ECU 110.

FIG. 3 is an explanatory diagram for authentication processing performed by ECUs for a message.

FIG. 4 shows an example of a transmission-reception sequence for control data communicated between ECUs 111 and 110.

FIG. 5 is a flowchart illustrating processing performed by the ECU 110.

FIG. 6 shows an example of a computer 2000.

### DESCRIPTION OF EXEMPLARY EMBODIMENTS

Hereinafter, embodiments of the present invention will be described, but the embodiments do not limit the invention according to the claims. In addition, not all of the combinations of features described in the embodiments are essential for solving means of the invention.

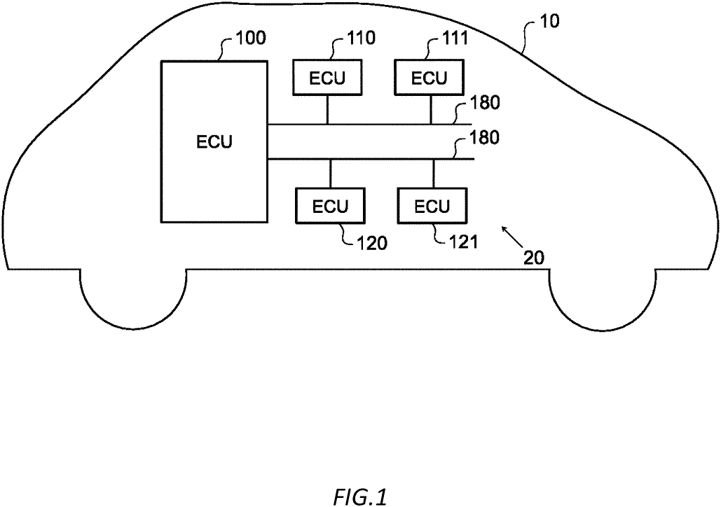

FIG. 1 conceptually shows the system configuration of a vehicle 10 in an embodiment. The vehicle 10 includes a system 20. The system 20 includes a plurality of electronic control units (ECUs) including ECUs 100, 110, 111, 120, and 121. The ECUs included in the vehicle 10 include ECUs for controlling devices that directly affect the travel of the vehicle 10, e.g., an engine, a speed changer, and a steering apparatus. The ECUs included in the vehicle 10 include ECUs for controlling devices that do not directly affect the travel of the vehicle 10, e.g., an air conditioner and a navigation apparatus. The ECUs 100, 110, 111, 120, and 121 are examples of in-vehicle devices.

The ECUs included in the vehicle 10 communicate with each other via controller area network (CAN) communication. The ECUs included in the vehicle 10 are each connected such that the ECUs can communicate with each other over a plurality of CAN communication networks 180. The ECU 100 functions as a gateway for relaying communication between the plurality of CAN communication networks 180.

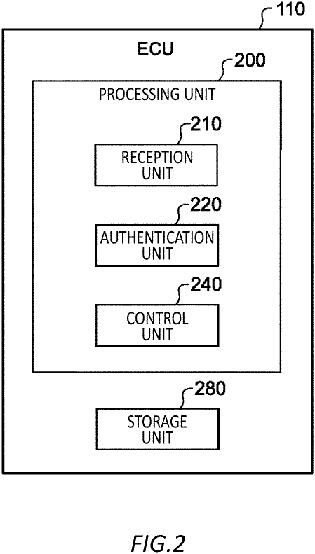

FIG. 2 is a block diagram schematically illustrating a functional configuration included in the ECU 110. The ECU 110 includes a processing unit 200 and a storage unit 280.

The processing unit 200 may be implemented by a processor such as a CPU that performs arithmetic processing. The storage unit 280 may include a nonvolatile storage medium such as a flash memory and a volatile storage medium such as a random access memory. The ECU 110 may be configured to include a computer. The ECU 110 performs various types of control by the processing unit 200 being operated in accordance with a program stored in the nonvolatile storage medium.

The processing unit 200 includes a reception unit 210, an authentication unit 220, and a control unit 240. The reception unit 210 receives, via control area network communication (CAN communication), a message including data and an authentication code for authenticating the data.

The authentication unit 220 authenticates data by using the authentication code included in the message. The control unit 240 performs control by using data included in the message when the authentication unit 220 has authenticated data included in a preset number of messages consecutively received by the reception unit 210. In embodiments, a preset number of messages consecutively received refer to a preset number of messages consecutively received among messages for which the same CAN ID is specified.

The authentication code is, for example, a message authentication code (MAC). In MAC authentication, the message authentication code is generated using a freshness value (FV). A transmission delay may occur between a transmission-side ECU and a reception-side ECU, depending on the distance on a communication path between the transmission-side ECU and the reception-side ECU and the transmission rate of CAN communication therebetween. Thus, there may be a difference between the FV at the time when the transmission-side ECU generated a MAC and the FV at the time when the reception-side ECU received a CAN data frame, thereby leading to inconsistency between the MACs. Even in a case where the MACs accidentally have such inconsistency, when data included in consecutively received messages is authenticated, the vehicle 10 is controlled using data included in the received messages, so that the influence of the MACs accidentally having inconsistency can be reduced.

The preset number is, for example, two. When the transmission-side ECU transmits the same type of data at intervals of 20 ms, two may be set as the preset number, so that it can be determined in 40 msec that there are no abnormalities in communication.

When data included in a preset number of messages consecutively received by the reception unit 210 is authenticated, the control unit 240 performs control by using data included in the last received message among the preset number of messages.

If a malicious third party makes a brute-force attack inputting false data frames to a CAN communication network 180, MAC authentication of a false data frame may possibly accidentally succeed. By contrast, using data in the latest message so as to control the vehicle 10 when data included in a preset number of messages consecutively received is authenticated allows the data for which MAC authentication had initially accidentally succeeded to be prevented from being used to control the vehicle 10.

Data included in consecutively received messages is such that the amount of variation in data values among consecutive messages is equal to or less than a preset value. As an example, data applied to the authentication processing performed by the authentication unit 220 for consecutive messages may be detected data pertaining to the yaw rate of the vehicle 10. The CAN communicates data at intervals of 20 msec, so when the preset number is two and a negative authentication result is obtained only once, the intervals at which data that can be used to control the vehicle 10 can be acquired will be 60 msec. Thus, substantial delay can be suppressed from occurring in the controlling of the vehicle 10 by causing the authentication unit 220 to perform authentication processing for data expected to have an amount of variation that is equal to or less than a preset value over a time interval of about 60 ms.

When data included in three messages consecutively received by the reception unit 210 is authenticated, the control unit 240 may perform control by using data included in the last received message among the three messages. Setting three as the preset number in such a manner can enhance the resistance to precise attacks from a malicious third party in comparison to when the preset number is two. Setting three as the preset number also allows a determination to be made as to whether treatments need to be made by a dealer.

The authentication code accounts for ½ or less of the length of the data field of a message. In this way, a data length can be ensured for data to be included in the data field.

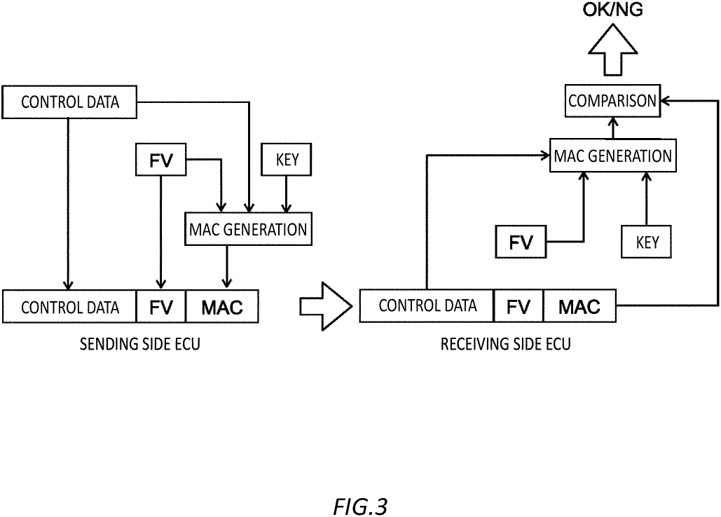

FIG. 3 is an explanatory diagram for authentication processing performed by ECUs for a message. FIG. 3 shows authentication processing performed when control data generated by a transmission-side ECU is transmitted/received to/from the transmission-side ECU and a reception-side ECU. The following descriptions are given on the assumption that the ECU 110 is the reception-side ECU.

The transmission-side ECU generates control data to be transmitted to the reception-side ECU. The control data is, for example, sensor data detected by a sensor. For example, the control data may be sensor data pertaining to, for example, a yaw rate and a vehicle speed.

The transmission-side ECU generates a MAC by using the control data, a freshness value (FV), and a key. The FV may be updated by the transmission-side ECU so as to prevent a resend attack. For example, the FV may be generated on the basis of a trip counter that is incremented every time an ignition (IG) power source of the vehicle 10 is turned on and a reset counter that is incremented at preset times. For example, the reset counter may be incremented every second. The key is a shared key shared between the transmission-side ECU and the reception-side ECU.

The transmission-side ECU sends a CAN data frame including the control data, the FV, and the MAC to a CAN communication network 180. For example, the transmission-side ECU stores the control data, the FV, and the MAC in a data field having a data length of 64 bits so as to send the same to the CAN communication network 180. The MAC accounts for ½ or less of the length of the data field. As an example, the MAC accounts for 24 bits of the data field. In this way, the control data to be stored in the data field can be suppressed from having a significantly decreased data length.

In the ECU 110, which is the reception-side ECU, the reception unit 210 receives the CAN data frame sent to the CAN communication network 180. The authentication unit 220 generates a MAC by using the control data, the FV, and the key included in the received data frame. The key is a shared key shared between the transmission-side ECU and the reception-side ECU. The authentication unit 220 may generate a MAC by using the FV included in the data frame. The authentication unit 220 may generate a MAC by using a FV updated by the ECU 110.

The authentication unit 220 determines whether an authentication result is positive or negative on the basis of a comparison between the generated MAC and the MAC included in the received data frame. For example, the authentication unit 220 determines that the authentication result is positive (OK) when the generated MAC matches the MAC included in the received data frame. The authentication unit 220 determines that the authentication result is negative (NG) when the generated MAC does not match the MAC included in the received data frame.

When the authentication result is negative, the authentication unit 220 may determine that an abnormality has occurred in the CAN communication network 180. Presentable examples of cases of the authentication result having the possibility of being negative may include a situation in which a FV updated by the transmission-side ECU does not match a FV updated by the reception-side ECU due to, for example, a transmission delay. Presentable examples of other cases of the authentication result having the possibility of being negative may include a situation in which control data is not transmitted normally due to, for example, noise in the CAN communication network 180. Presentable examples of other cases of the authentication result having the possibility of being negative may include a situation in which the key held by the transmission-side ECU does not match the key held by the reception-side ECU. Presentable examples of situations in which the key held by the transmission-side ECU does not match the key held by the reception-side ECU include, for example, a situation in which: control software for the transmission-side ECU and control software for the reception-side ECU undergo a software update over the air (in an OTA manner); and the control software for one of the transmission-side ECU or the reception-side ECU is not updated normally. Presentable examples of other cases of the authentication result having the possibility of being negative include a situation in which a malicious third party inputs an illicit data frame to the CAN communication network 180.

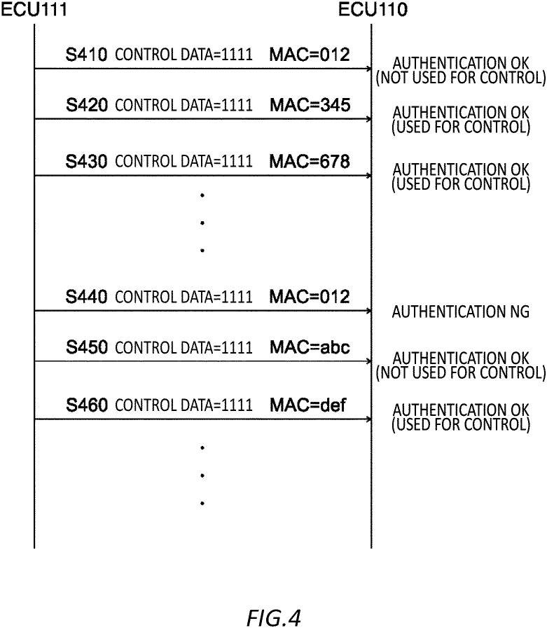

FIG. 4 shows an example of a transmission-reception sequence for control data communicated between the ECUs 111 and 110. In this example, the ECU 111 is a transmission-side ECU, and the ECU 110 is a reception-side ECU. At a point in time at which the transmission-reception sequence of FIG. 4 starts after the IG power source of the vehicle 10 is turned on, communication that includes authentication processing using a MAC is not performed between the ECUs 111 and 110.

In S410, the ECU 111 sends a data frame including the latest control data and MAC to the CAN communication network 180. Upon the ECU 110 receiving the data frame, the authentication unit 220 performs the above-described authentication processing and obtains a positive authentication result (authentication OK). In this step, the control unit 240 does not use, for the controlling of the vehicle 10, the control data included in the received data frame.

In S420, the ECU 111 sends a data frame including the latest control data and MAC to the CAN communication network 180. Upon the ECU 110 receiving the data frame, the authentication unit 220 performs the above-described authentication processing and obtains a positive authentication result (authentication OK). In this case, the control unit 240 controls the vehicle 10 by using the control data included in the received data frame.

In S430, the ECU 111 sends a data frame including the latest control data and MAC to the CAN communication network 180. Upon the ECU 110 receiving the data frame, the authentication unit 220 performs the above-described authentication processing and obtains a positive authentication result (authentication OK). In this case, the control unit 240 controls the vehicle 10 by using the control data included in the received data frame. In the subsequent steps, similarly, upon the ECU 110 receiving a data frame, the authentication unit 220 performs the above-described authentication processing and, every time a positive authentication result is obtained, controls the vehicle 10 by using control data included in the received data frame.

In S440, the ECU 111 sends a data frame including the latest control data and MAC to the CAN communication network 180. Upon the ECU 110 receiving the data frame, the authentication unit 220 performs the above-described authentication processing and obtains a negative authentication result (authentication NG). In this case, the control unit 240 discards the control data included in the received data frame and does not control the vehicle 10 by using the control data.

In S450, the ECU 111 sends a data frame including the latest control data and MAC to the CAN communication network 180. Upon the ECU 110 receiving the data frame, the authentication unit 220 performs the above-described authentication processing and obtains a positive authentication result (authentication OK). In this case, the control unit 240 does not use, for the controlling of the vehicle 10, the control data included in the received data frame.

In S460, the ECU 111 sends a data frame including the latest control data and MAC to the CAN communication network 180. Upon the ECU 110 receiving the data frame, the authentication unit 220 performs the above-described authentication processing and obtains a positive authentication result (authentication OK). In this case, the control unit 240 controls the vehicle 10 by using the control data included in the received data frame. In the subsequent steps, similarly, upon the ECU 110 receiving a data frame, the authentication unit 220 performs the above-described authentication processing and, every time a positive authentication result is obtained, controls the vehicle 10 by using control data included in the received data frame.

In the ECU 110, as described above, when a positive authentication result is obtained consecutively twice or more for consecutively received data frames, the authentication unit 220 controls the vehicle 10 by using control data included in the latest received data frame.

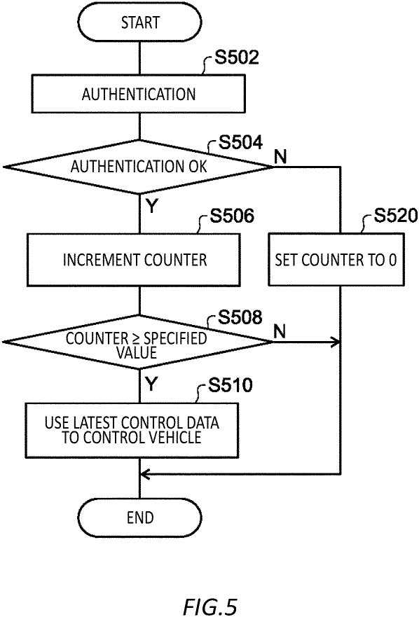

FIG. 5 is a flowchart illustrating processing performed by the ECU 110. The processing of the flowchart shown in FIG. 5 is performed every time a data frame is received.

In S502, the authentication unit 220 performs authentication processing for a received data frame. For example, the authentication unit 220 performs the authentication processing described above with reference to FIG. 3 and the like.

In S504, the authentication unit 220 determines whether a positive authentication result has been obtained. When a positive authentication result is not obtained, 0 is set, in S520, for a counter indicating the number of times a positive authentication result has been consecutively obtained, and the processing of the flowchart ends.

When it is determined in S504 that a positive authentication result has been obtained, the authentication unit 220 increments the counter in S506. In S508, it is determined whether the value of the counter is equal to or higher than a specified value. The specified value is, for example, two. As another example, the specified value may be, for example, three. When the value of the counter is lower than the specified value, the processing of the flowchart ends. When the value of the counter is equal to or higher than the specified value, in S510, the control data included in the received data frame is used to control the vehicle 10.

In the ECU 110, as described above, when a positive authentication result is obtained consecutively as many times as is equal to or greater than the specified value for consecutively received data frames, the authentication unit 220 accepts control data included in the latest received data frame, so as to control the vehicle 10.

In CAN communication, the data length of the data field of a data frame is 64 bits. When performing authentication using MACs in CAN communication, control data needs to be stored in the data field, so a MAC with a great bit length cannot be stored. The greater the bit length of a MAC is, the greater the encryption strength is, while the less the bit length of the MAC is, the less the encryption strength is, so the less bit length the MAC accounts for in the data field, the less the encryption strength is. For example, when MACs have a data length of 24 bits, the probability of the MACs matching each other is ½²⁴ according to simple calculation. Accordingly, if a malicious third party performs spoofing to transmit a data frame as if the same was originating from a source ECU, it can be said that the spoofing will succeed with a probability of ½²⁴.

By contrast, by employing the configuration in which, as described above with reference to the embodiments, control data is accepted under the condition that the authentication result is positive for two consecutively received data frames, the MACs can match each other with a probability of (½²⁴)×(½²⁴)=½⁴⁸ according to simple calculation. In this way, high encryption strength can be ensured, with the MAC authentication being applied to an existing CAN communication network. Accordingly, the MAC authentication with high encryption strength can be applied at low cost without the need to make a major change in the specifications of a communication protocol.

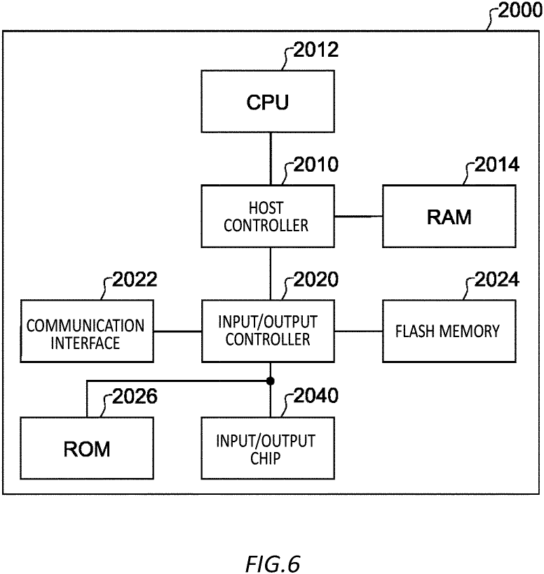

FIG. 6 shows an example of a computer 2000 that may entirely or partially implement a plurality of embodiments of the present invention. A program installed in the computer 2000 can allow the computer 2000 to: function as systems such as the system 20 according to embodiments or components of the systems, or as apparatuses such as the ECU 110 or components of the apparatuses; perform operations associated with the systems or components of the systems or with the apparatuses or components of the apparatuses; and/or perform processes according to embodiments or steps in the processes. Such a program may be executed by a CPU 2012 to cause the computer 2000 to perform certain operations associated with the processing procedures described herein and some of or all of the blocks in the block diagrams.

The computer 2000 according to present embodiments includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, thereby controlling each unit.

The communication interface 2022 communicates with other electronic devices via a network. The flash memory 2024 stores programs and data used by the CPU 2012 within the computer 2000. The ROM 2026 stores therein a boot program or the like executed by the computer 2000 at the time of activation, and/or a program depending on the hardware of the computer 2000. The input/output chip 2040 may connect various input/output units such as a keyboard, a mouse, and a monitor to the input/output controller 2020 via input/output ports such as a serial port, a parallel port, a keyboard port, a mouse port, a monitor port, a USB port, and a HDMI (registered trademark) port.

A program is provided via a network or computer-readable storage media such as a CD-ROM, a DVD-ROM, or a memory card. The RAM 2014, the ROM 2026, or the flash memory 2024 is an example of the computer-readable storage medium. Programs are installed in the flash memory 2024, the RAM 2014, or the ROM 2026 and executed by the CPU 2012. The information processing written in these programs is read by the computer 2000, and thereby cooperation between a program and the above-described various types of hardware resources is achieved. An apparatus or method may be constituted by carrying out the operation or processing of information by using the computer 2000.

For example, when communication is carried out between the computer 2000 and an external device, the CPU 2012 may execute a communication program loaded onto the RAM 2014 to instruct the communication interface 2022 to perform communication processing, based on the processing written in the communication program. The communication interface 2022, under control of the CPU 2012, reads transmission data stored on transmission buffering regions provided in recording media such as the RAM 2014 and the flash memory 2024, and transmits the read transmission data to a network and writes reception data received from a network to reception buffering regions or the like provided on the recording media.

In addition, the CPU 2012 may cause all or necessary portions of a file or a database to be read into the RAM 2014, the file or the database having been stored in a recording medium such as the flash memory 2024, etc., and perform various types of processing on the data on the RAM 2014. The CPU 2012 may then write back the processed data to the recording medium.

Various types of information, such as various types of programs, data, tables, and databases, may be stored in the recording medium to undergo information processing. The CPU 2012 may perform various types of processing on the data read from the RAM 2014, which includes various types of operations, information processing, conditional judging, conditional branch, unconditional branch, search/replace of information, etc., as described herein and designated by an instruction sequence of programs, and writes the result back to the RAM 2014. In addition, the CPU 2012 may search for information in a file, a database, etc., in the recording medium. For example, when a plurality of entries, each having an attribute value of a first attribute associated with an attribute value of a second attribute, are stored in the recording medium, the CPU 2012 may search for an entry matching the condition whose attribute value of the first attribute is designated, from among the plurality of entries, and read the attribute value of the second attribute stored in the entry, thereby acquiring the attribute value of the second attribute associated with the first attribute satisfying the preset condition.

The programs or software modules described above may be stored in the computer-readable storage medium on the computer 2000 or in the vicinity of the computer 2000. A recording medium such as a hard disk or a RAM provided in a server system connected to a dedicated communication network or the Internet can be used as the computer-readable storage media. A program stored in the computer-readable storage medium may be provided to the computer 2000 via a network.

Programs that are installed in the computer 2000 and cause the compute 2000 to function as the ECU 110 may contact the CPU 2012 or the like so as to cause the computer 2000 to function as each unit of the slave ECU 110. The information processing described in these programs is read into the computer 2000 so as to function as each unit of the ECU 110, which is constituted by specific means in which software and the above-mentioned various types of hardware resources cooperate with each other. Then, by the specific means realizing calculation or processing of information according to a purpose of use of the computer 2000 in present embodiments, the unique ECU 110 according to the purpose of use is constructed.

Various embodiments have been described by referring to the block diagrams and the like. Each block in the block diagrams may represent (1) steps of processes in which operations are performed or (2) units of apparatuses responsible for performing operations. Certain steps and units may be implemented by dedicated circuitry, programmable circuitry supplied with computer-readable instructions stored on computer-readable storage media, and/or processors supplied with computer-readable instructions stored on computer-readable storage media. Dedicated circuit may include digital and/or analog hardware circuits and may include integrated circuits (IC) and/or discrete circuits. Programmable circuit may include reconfigurable hardware circuits including logical AND, logical OR, logical XOR, logical NAND, logical NOR, and other logical operations, flip-flops, registers, memory elements, etc., such as field-programmable gate arrays (FPGA), programmable logic arrays (PLA), etc.

Computer-readable storage media may include any tangible device that can store instructions for execution by a suitable device, such that the computer-readable storage medium having instructions stored therein forms at least a portion of an article of manufacture including instructions which can be executed to create means for performing processing operations or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disk (DVD), a Blu-ray (registered trademark) disk, a memory stick, an integrated circuit card, or the like.

The computer-readable instruction may include an assembler instruction, an instruction-set-architecture (ISA) instruction, a machine instruction, a machine dependent instruction, a microcode, a firmware instruction, state-setting data, or either of source code or object code written in any combination of one or more programming languages including an object-oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, special purpose computer, or other programmable data processing apparatus, or to programmable circuit, locally or via a local area network (LAN), wide area network (WAN) such as the Internet, etc., to execute the computer-readable instructions to provide means for performing described processing procedure or operations specified in the block diagrams. Examples of the processor include a computer processor, a processing unit, a microprocessor, a digital signal processor, a controller, a microcontroller, and the like.

While the present invention has been described with the embodiments, the technical scope of the present invention is not limited to the above-described embodiments. It is apparent to persons skilled in the art that various alterations and improvements can be added to the above-described embodiments. It is also apparent from what is set forth in the claims that embodiments having such alterations or improvements added thereto can be included in the technical scope of the invention.

It should be noted that processes in, for example, the operations, procedures, steps, and stages performed by the apparatus, system, program, and method shown in the claims, specification, or diagrams can be performed in any order, as long as the order is not specifically indicated by “prior to,” “before,” or the like and as long as the output from a previous process is not used in a later process. Even if the process flow is described using phrases such as “first” or “next” in the claims, specification, or drawings, it does not necessarily mean that the process must be performed in this order.

### EXPLANATION OF REFERENCES

| | |
|---|---|
| 10: | vehicle; |
| 20: | system; |
| 100: | ECU; |
| 110: | ECU; |
| 111: | ECU; |
| 120: | ECU; |
| 121: | ECU; |
| 180: | CAN communication network; |
| 200: | processing unit; |
| 210: | reception unit; |
| 220: | authentication unit; |
| 240: | control unit; |
| 280: | storage unit; |
| 2000: | computer; |
| 2010: | host controller; |
| 2012: | CPU; |
| 2014: | RAM; |
| 2020: | input/output controller; |
| 2022: | communication interface; |
| 2024: | flash memory; |
| 2026: | ROM; |
| 2040: | input/output chip. |

What is claimed is:

1. An in-vehicle device comprising:
a reception unit configured to receive, via control area network communication (CAN communication), a message including data and an authentication code for authenticating the data;
an authentication unit configured to authenticate the data by using the authentication code; and
a control unit configured to perform, when the authentication unit has authenticated data included in a preset number of messages consecutively received by the reception unit, control by using the data included in the message.

2. The in-vehicle device according to claim 1, wherein
the preset number is two.

3. The in-vehicle device according to claim 1, wherein
when the data included in the preset number of messages consecutively received by the reception unit is authenticated, the control unit is configured to perform control by using data included in a last received message among the preset number of messages.

4. The in-vehicle device according to claim 1, wherein
the data included in the consecutively received messages is such that an amount of variation in data values among consecutive messages is equal to or less than a preset value.

5. The in-vehicle device according to claim 1, wherein
when data included in three messages consecutively received by the reception unit is authenticated, the control unit is configured to perform control by using data included in a last received message among the three messages.

6. The in-vehicle device according to claim 1, wherein
the authentication code accounts for ½ or less of a length of a data field of the message.

7. The in-vehicle device according to claim 2, wherein
when the data included in the preset number of messages consecutively received by the reception unit is authenticated, the control unit is configured to perform control by using data included in a last received message among the preset number of messages.

8. The in-vehicle device according to claim 2, wherein
the data included in the consecutively received messages is such that an amount of variation in data values among consecutive messages is equal to or less than a preset value.

9. The in-vehicle device according to claim 3, wherein
the data included in the consecutively received messages is such that an amount of variation in data values among consecutive messages is equal to or less than a preset value.

10. The in-vehicle device according to claim 7, wherein
the data included in the consecutively received messages is such that an amount of variation in data values among consecutive messages is equal to or less than a preset value.

11. The in-vehicle device according to claim 2, wherein
when data included in three messages consecutively received by the reception unit is authenticated, the control unit is configured to perform control by using data included in a last received message among the three messages.

12. The in-vehicle device according to claim 3, wherein
when data included in three messages consecutively received by the reception unit is authenticated, the control unit is configured to perform control by using data included in a last received message among the three messages.

13. The in-vehicle device according to claim 4, wherein
when data included in three messages consecutively received by the reception unit is authenticated, the control unit is configured to perform control by using data included in a last received message among the three messages.

14. The in-vehicle device according to claim 2, wherein
the authentication code accounts for ½ or less of a length of a data field of the message.

15. The in-vehicle device according to claim 3, wherein
the authentication code accounts for ½ or less of a length of a data field of the message.

16. The in-vehicle device according to claim 4, wherein
the authentication code accounts for ½ or less of a length of a data field of the message.

17. The in-vehicle device according to claim 5, wherein
the authentication code accounts for ½ or less of a length of a data field of the message.

18. A vehicle comprising the in-vehicle device according to claim 1.

19. A method comprising:
receiving, via control area network communication (CAN communication), a message including data and an authentication code for authenticating the data;
authenticating the data by using the authentication code; and
when data included in two consecutively received messages is authenticated in the authenticating the data, performing control by using data included in a last received message among the two messages.

20. A method comprising:
receiving, via control area network communication (CAN communication), a first message including first data and a first authentication code for authenticating the first data;
authenticating the first data by using the first authentication code;
receiving, via the CAN communication, a second message including second data and a second authentication code for authenticating the second data;
authenticating the second data by using the second authentication code; and
when the first and second messages are consecutively received messages, the first data is authenticated in the authenticating the first data, and the second data is authenticated in the authenticating the second data, performing control by using the second data included in the second message.
